(19) United States
(12) Patent Application Publication
(10) Pub. No.: US 2016/0147989 A1
(43) Pub. Date: May 26, 2016

(54) METHOD AND SYSTEM FOR AUTHENTICATING ACCESS TO A COMPUTING DEVICE

(71) Applicant: Narasimha Rao VENKATA DONGALA, Guntur (IN)

(72) Inventor: Narasimha Rao VENKATA DONGALA, Guntur (IN)

(73) Assignee: Wipro Limited, Bangalore (IN)

(21) Appl. No.: 14/618,908

(22) Filed: Feb. 10, 2015

(30) Foreign Application Priority Data
Nov. 25, 2014 (IN) 5908/CHE/2014

(51) Int. Cl. G06F 21/36

(52) U.S. Cl. CPC G06F 21/36

(57) ABSTRACT

Embodiments of the present disclosure disclose a method and a system for authenticating access to a computing device. The method comprises providing a user interface on a display of the computing device. The user interface comprises a grid comprising a plurality of colorable grid cells and a plurality of colors to be filled in the plurality of colorable grid cells. The method further comprises receiving a pattern from the user, wherein the pattern comprises of a plurality of colored grid cells and order of coloring of the plurality of colored grid cells. The method further comprises comparing the pattern received from the user with a predefined pattern. The method further comprises providing access to the computing device based on the comparison.

### PRIORITY CLAIM

This U.S. patent application claims priority under 35 U.S.C. §119 to: India Application No. 5908/CHE/2014. The entire contents of the aforementioned application are incorporated herein by reference.

### TECHNICAL FIELD

The present subject matter is related, in general to authentication techniques and more particularly, but not exclusively to a method and a system for authenticating access to a computing device.

### BACKGROUND

A computing device including user information should only allow access of a permitted user. This is because computing devices including, but are not limited to, mobile phones, tablets, and smartphones have become an integral part of many people's lives given the portability, the convenient access to the Internet, and the growing number of applications available on such devices. For example, using a smart phone, individuals can perform online banking, shopping, and other functions. Many smartphone browsers can be configured by users to remember passwords, form data, and other information. Furthermore, smartphones also store the names and addresses of contacts. Therefore, smartphones are not only used for making calls but also for carrying personal and sensitive information of an individual. The technology of determining whether access to such computing devices is tried by a permitted lawful user is called a user authentication technology.

Computing devices generally provide for lock screens to prevent unauthorized or unintentional access to the device. A lock screen is a user interface which regulates immediate access to a device by requiring the user to perform a certain action, such as by entering a password or by performing a certain gesture in order to receive access. However, a general user authentication technology using a personal identification number (PIN) is weak against shoulder surfing or a recording attack by a third person, or a spyware/key logger attack since a password of a user is exposed as it is.

Another most widely used method for user authentication is the pattern lock. The pattern locking is very popular because of its interesting and fun way to unlock the mobile unlike a password entry mechanism. However, this pattern lock is vulnerable because of following reasons. Firstly, if anyone sees the pattern while unlocking by the user, they can easily remember and can hack the pattern. This is because the dots are connected via line and the connected dots are adjacent to each other. Secondly, if the screen of the mobile phone is closely observed immediately after it is unlocked, finger swipe marks can be seen on the screen which in turn leads to hacking the pattern. Gesture unlock patterns set up by an authorized user can be discovered by viewing the finger smudge path on the glass. This smudge path is particularly visible when the screen is dark and the unlock gesture is traced out many times in a more intentional fashion where the user exerts more finger pressure.

### SUMMARY

Disclosed herein is a method and system for authenticating access to computing device. The method comprises providing, by a processor of the computing device, a user interface on a display of the computing device. The user interface comprises a grid comprising a plurality of colorable grid cells and a plurality of colors to be filled in the plurality of colorable grid cells. Further, the method comprises receiving a pattern from the user, wherein the pattern comprises of a plurality of colored grid cells and order of coloring of the plurality of colored grid cells. Further, the method comprises comparing the pattern received from the user with a predefined pattern and providing, access to the computing device based on the comparison.

In an aspect of the present disclosure, a computing device for providing authenticated access is disclosed. The computing device comprises a processor and a memory communicatively coupled to the processor. The memory stores processor-executable instructions which on execution, causes the processor to provide a user interface on a display of the computing device, wherein the user interface comprises a grid comprising a plurality of colorable grid cells and a plurality of colors to be filled in the plurality of colorable grid cells. Further, the processor receives a pattern from the user, wherein the pattern comprises of a plurality of colored grid cells and order of coloring of the plurality of colored grid cells. Further, the processor compares the pattern received from the user with a predefined pattern and provides access to the computing device based on the comparison.

In another aspect of the present disclosure, a non-transitory computer readable medium for is disclosed. The non-transitory computer readable medium includes instructions stored thereon that when processed by a processor causes a system to perform operations comprising providing a user interface on a display of the computing device, wherein the user interface comprises a grid comprising a plurality of colorable grid cells and a plurality of colors to be filled in the plurality of colorable grid cells. The operations further comprise receiving a pattern from the user, wherein the pattern comprises of a plurality of colored grid cells and order of coloring of the plurality of colored grid cells. The operations further comprise comparing the pattern received from the user with a predefined pattern and providing access to the computing device based on the comparison.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The patent or application file contains at least one drawing executed in color. Copies of this patent or patent application publication with color drawing(s) will be provided by the Office upon request and payment of the necessary fee.

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a block diagram of an exemplary computing device to authenticate access in accordance with some embodiments of the present disclosure;

FIGS. 2A and 2B illustrate an exemplary user interface of computing device to authenticate user access in accordance with some embodiments of the present disclosure;

FIG. 3 shows a flowchart illustrating a method for storing a pattern for authenticating user access to a computing device in accordance with some embodiments of the present disclosure;

FIG. 4 shows a flowchart illustrating a method for authenticating access to a computing device in accordance with some embodiments of the present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure are related to a method and a system for authenticating access to a computing device. In particular, the method of present disclosure is implemented in lock screen of a computing device, for example, mobile phone. The method comprise displaying a lock screen view with a colorable grid cells to prevent unauthorized or inadvertent access to the data of computing device, while the computing device is locked. The pattern for unlocking the computing device is a combination of colors of the colorable grid cells and the order in which cells are colored. The user of the computing device inputs a pattern to access the computing device. The mobile device is unlocked and access is provided to the user in response to the user successfully providing the verification pattern.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

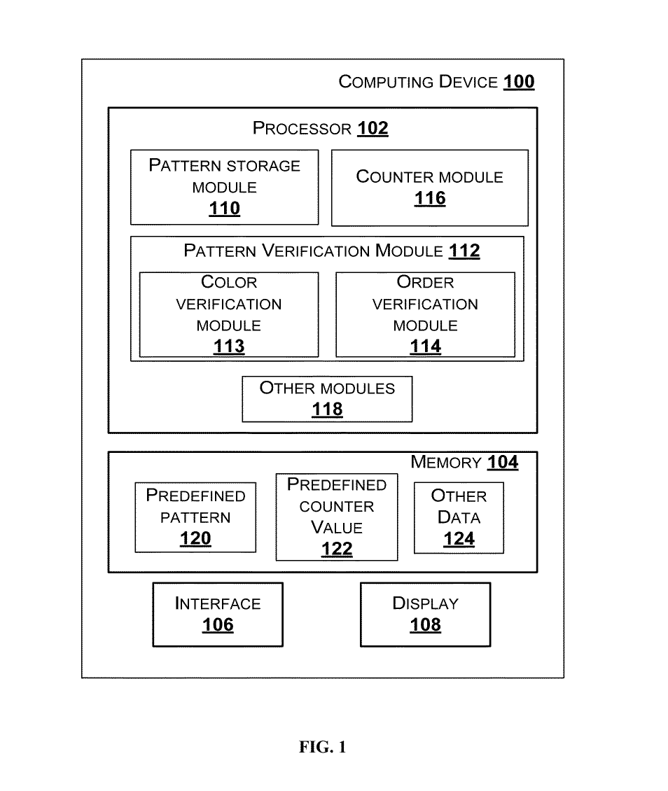

FIG. 1 illustrates a block diagram of an exemplary computing device to authenticate access in accordance with some embodiments of the present disclosure. The computing unit 100 may include at least one central processing unit (“CPU” or “processor”) 102 and a memory 104 storing instructions executable by the at least one processor 102. The processor 102 may comprise at least one data processor for executing program components for executing user- or system-generated requests. A user may include a person, a person using a device such as those included in this disclosure, or such a device itself. The memory 104 is communicatively coupled to the processor 102. In an embodiment, the memory 104 stores pattern defined by the user for accessing the computing device 100.

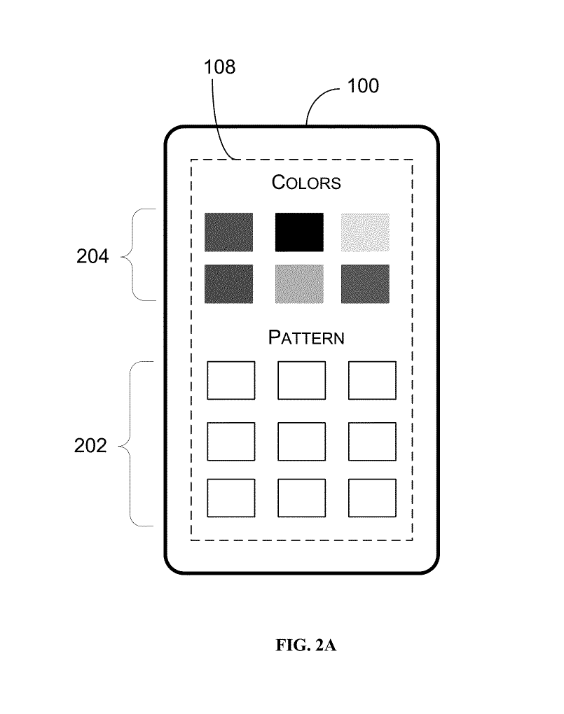

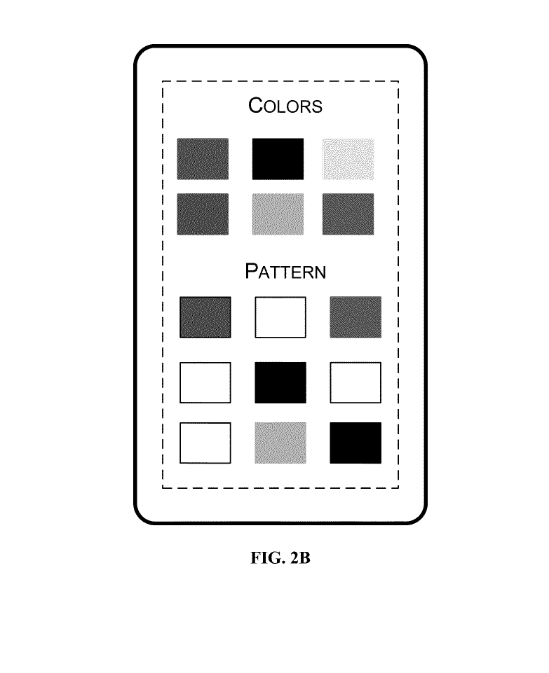

The computing system further comprises an I/O interface 106 and a display 108. The I/O interface 106 is coupled with the processor 102 through which the user input is received. The display 108 is used to display a user interface for authenticating access of the user to the computing device 100. An exemplary embodiment of user interface is illustrated in FIG. 2A. The user interface comprises a grid comprising a plurality of colorable grid cells 202 and a plurality of colors 204 to be filled in the plurality of colorable grid cells 202. As shown, a grid comprising 3-by-3 elements is displayed to serve as a guide. Note that while a 3-by-3 grid is used to illustrate various embodiments, other grid sizes may also be incorporated. Also, the plurality of colorable grid cells 202 may be randomly placed on the display 108 of the computing device 100. Also, the grid cells may be of any shape like square, circle, oval etc. without departing from the scope of the present disclosure.

The display 108 is also configured to act as user interface, thereby receiving input from the user. The input from the user can be any input that results from contact or contactless gesture with the user interface. Contact input can either be made directly, such as touching a user interface with a finger, or indirectly by using an implement, such as a stylus, to act as an intermediary. Contactless input can be air gesture like swiping, pointing in the air in front of the user interface. A non-exhaustive list of user interfaces capable of detecting tactile input includes: touch screens, knobs, dials, buttons, switches, joy sticks, and levers, for example.

As an example, the computing device 100 may include, but are not limited to, smart phones, tablets, Global Positioning System (GPS) receivers, Television (TV) remote controls, personal digital assistants (PDAs), audio- and video-file players (e.g., MP3 players and iPODs), digital cameras, and e-book readers (e.g., Kindles and Nooks). For purposes of these teachings, a computing device can be any device that comprises at least one user interface, is capable of storing a user pattern, and that also has the ability to receive input from the user, and provide access to the user based on the input.

In an embodiment, one or more data may be stored within the memory 104. The one or more data may include, for example, a predefined pattern 120, a predefined counter value 122, and other data 124.

The predefined pattern 120 is a pattern received from the user initially. The predefined pattern 120 may be stored in the memory 104 of the computing device 100. In an embodiment, the predefined pattern 120 comprises color of the colored grid cell and order of coloring of the colored grid cells. The color of the colored grid cells may be stored as RGB value in the memory 104. Further, the order of coloring of the colored grid cells may be represented by pixel/location value of the colored grid cells in the memory 104. Each time user requests access to the computing device 100, the user is prompted to enter the pattern for unlocking the computing device 100. The pattern entered by user is then compared with the predefined pattern 120 for authenticating the user. In an exemplary embodiment, the predefined pattern 120 may be changed by the user.

The predefined counter value 122 comprises a threshold value for maximum unsuccessful attempts or wrong input by the user. If the number of unsuccessful attempts by the user exceeds the predefined counter value 122, then the computing device 100 may be permanently locked.

In an embodiment, the data in the memory 104 and input received from the user received from the user are processed by the modules of the processor 102. The modules may be stored within the memory 104.

In one implementation, the modules may include, for example, a pattern storage module 110, a pattern verification module 112, an order verification module 114 and a counter module 116. The system 100 may also comprise other modules 118 to perform various miscellaneous functionalities of the computing device 100. It will be appreciated that such aforementioned modules may be represented as a single module or a combination of different modules.

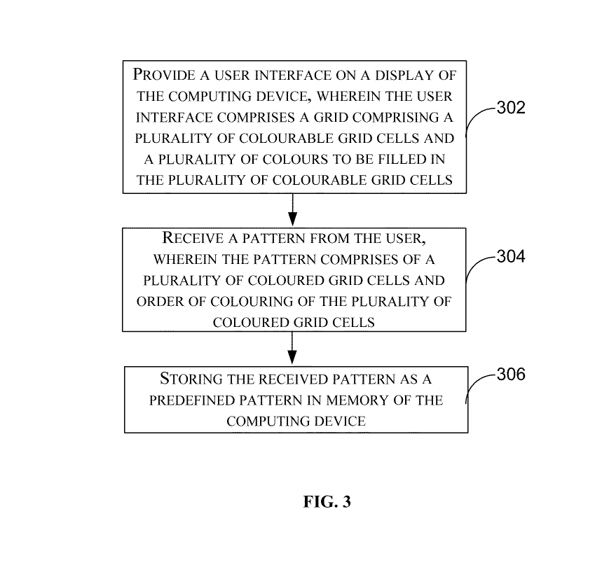

In an embodiment, the pattern storage module 110 stores the pattern received from the user as a predefined pattern 120 in the memory 104 of the computing device 100. In order to prevent the computing device from unauthorized access, the user, the user may be prompted to enter a pattern. The pattern received from the user may be then stored in the memory 104 as a predefined pattern 120, which in turn is used to unlock the computing device 100. The process of storing a predefined pattern 120 is illustrated in FIG. 3.

FIG. 3 shows a flowchart illustrating a method for storing a pattern for authenticating user access to a computing device in accordance with some embodiments of the present disclosure.

As illustrated in FIG. 3, the method comprises one or more blocks for storing a pattern for authenticating user access to the computing device 100. The method may be described in the general context of computer executable instructions. Generally, computer executable instructions can include routines, programs, objects, components, data structures, procedures, modules, and functions, which perform particular functions or implement particular abstract data types.

The order in which the method is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 302, provide a user interface on a display 108 of the computing device 100. The user interface includes a grid comprising a plurality of colorable grid cells 202 and a plurality of colors 204 to be filled in the plurality of colorable grid cells 202.

At block 304, receive a pattern from the user. The pattern comprises of a plurality of colored grid cells and order of coloring of the plurality of colored grid cells as illustrated in FIG. 2B. The pattern can be received from the user in one or more ways. In an embodiment, the user can touch/air gesture on a color from the plurality of colors 204 to select the color. Then, the user can touch/air gesture on a colorable grid cell from the plurality of grid cells. By this, the selected color is applied on the selected colorable grid cell.

In an embodiment, the user can drag a color from the plurality of colors 204 and then drop the dragged color on a colorable grid cell. In this way, the colorable grid cell is colored with the color selected by the user.

In an embodiment, the user can touch/gesture over a colorable grid cell. Upon determining selection of a colorable grid cell, a plurality of colors may be displayed around the colorable grid cell. The user can touch/air gesture over any of the color to apply the color on the selected colorable grid cell. It may be noted that the plurality of colors may be applied to the grid cells in other numerous other ways without deviating from scope of the present subject matter.

At block 306, store the received pattern as a predefined pattern 120 in memory of the computing device 100.

Referring back to FIG. 1, the pattern verification module 112 verifies the pattern entered by user to access the computing device 100 with the predefined pattern 120 stored in the memory 104 of the computing device 100. The pattern verification module 112 in turn, comprises color verification module 113 and order verification module 114. The color verification module 113 verifies the colors input by the user with the colors in the predefined pattern 120. In an embodiment, once a user selects and applies a color on the colorable grid cell, then the RGB value of the color is sent to the color verification module 113. The color verification module 113 then compares Red Green Blue (RGB) value of the colors input by the user with the RGB value of the colors in the predefined pattern 120. The order verification module 114 verifies the order in which the colors are input with the order in the predefined pattern 120. In an embodiment, the pixel/location values of each colorable grid cell are used to determine the order of the coloring of the colorable grid cells 202. Once a user selects the colorable grid cell in an order, then the pixel value of the colored grid cell is sent to the order verification module 114 in the same order. The order of pixel values is then compared with the order stored in the predefined pattern 120.

The counter module 116 maintains the counter value of a counter for each wrong input by the user. Initially, the counter value is set to zero. In an embodiment, the counter value is incremented each time upon determining the pattern received from the user to be different from the predefined pattern 120. Further, the counter module resets the counter value upon determining the pattern entered by the user to be matching with the predefined pattern 120.

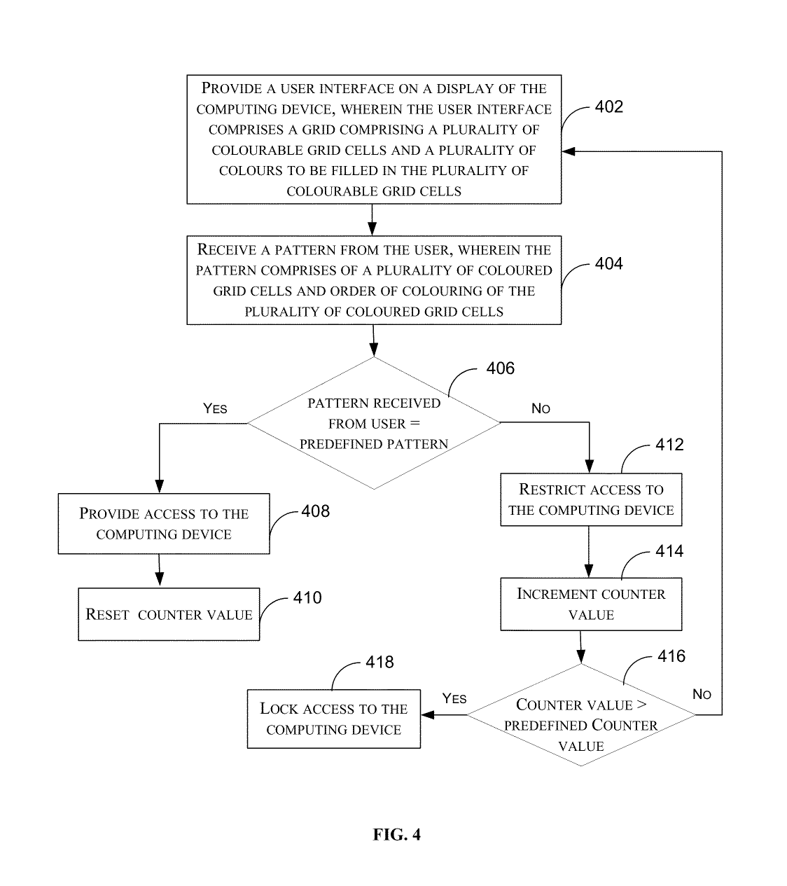

FIG. 4 shows a flowchart illustrating a method for authenticating access to a computing device in accordance with some embodiments of the present disclosure.

As illustrated in FIG. 4, the method comprises one or more blocks for authenticating access to the computing device 100. The method may be described in the general context of computer executable instructions. Generally, computer executable instructions can include routines, programs, objects, components, data structures, procedures, modules, and functions, which perform particular functions or implement particular abstract data types.

The order in which the method is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 402, provide a user interface on a display 108 of the computing device 100. In an embodiment, the user interface comprises a grid comprising a plurality of colorable grid cells 202 and a plurality of colors 204 to be filled in the plurality of colorable grid cells 202.

At block 404, receive a pattern from the user. The method for receiving the pattern is same as explained in block 320. The pattern received by the user comprises of a plurality of colored grid cells and order of coloring of the plurality of colored grid cells. As an example, refer to FIG. 2B, which illustrates the pattern. The plurality of colored grid cells comprises a red cell, two black cells, a green cell and a blue cell. Further, the order of coloring may be blue cell, followed by black cell followed by red cell followed by green cell followed by black cell again.

At block 406, compare the pattern received from the user with a predefined pattern. In an embodiment, firstly the colors of plurality of colored grid cells are compared with colors of the plurality of predefined colored grid cells by the color verification module 103. Then, the order of coloring of the plurality of grid cells is compared with predefined order of coloring of the plurality of predefined colored grid cells by the color verification module 104.

At block 412, if the pattern received from the user does not match with the predefined pattern 120, restrict access to the computing device 100. Then at block 414, counter value of a counter is incremented to count the number of unsuccessful attempts. Then at step 416, the counter value is compared with the predefined counter value 122. If the counter value is less than the predefined counter value 122, the user can again try to access the computing device and the method proceeds to block 402. In an embodiment, position of the one or more colors of the plurality of colors 204 is changed in the user interface. In the alternative, if the counter value is greater than the predefined counter value 122, the access to the computing device 100 is locked permanently. The user cannot again try to access the computing device. The computing device 100 may allow the user to try to unlock after some time.

At block 408, if the pattern received from the user matches with the predefined pattern, provide access to the computing device 100. Considering the above example, if the colors of the pattern entered by the user, i.e. a red cell, two black cells, a green cell and a blue cell matches with the colors in the predefined pattern 120, then the order of the coloring is verified. Now, if the order entered by the user, i.e. blue cell, followed by black cell followed by red cell followed by green cell followed by black cell again also matches with the order in the predefined pattern 120, the pattern is said to be matched.

In an embodiment, if after few unsuccessful attempts below the predefined counter value 122 the user successfully enters the correct pattern, then the counter is reset at block 410.

### Computer System

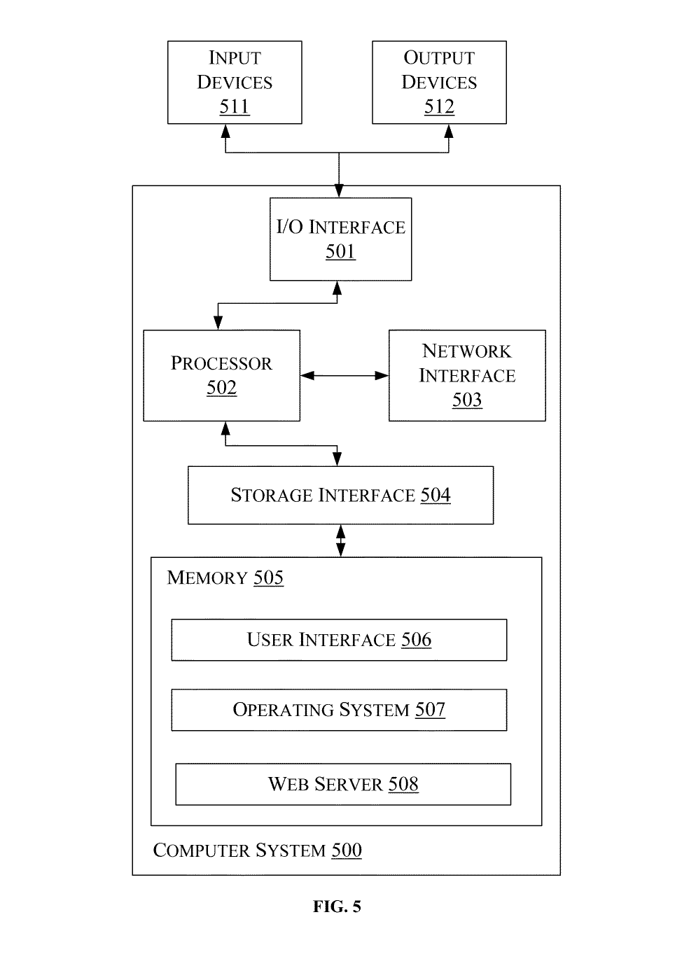

FIG. 5 illustrates a block diagram of an exemplary computer system 500 for implementing embodiments consistent with the present disclosure. In an embodiment, the computer system 500 is used to implement the computing device 100. The computer system 500 monitors the health condition of a subject. The computer system 700 may comprise a central processing unit (“CPU” or “processor”) 502. The processor 502 may comprise at least one data processor for executing program components for executing user- or system-generated business processes. A user may include a person, a person using a device such as those included in this disclosure, or such a device itself. The processor 502 may include specialized processing units such as integrated system (bus) controllers, memory management control units, floating point units, graphics processing units, digital signal processing units, etc.

The processor 502 may be disposed in communication with one or more input/output (I/O) devices (511 and 512) via I/O interface 501. The I/O interface 501 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices (511 and 512). For example, the input device 511 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 512 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface application 506, an operating system 507, web server 508 etc. In some embodiments, computer system 500 may store user/application data 506, such as the data, variables, records, etc. as described in this disclosure. Such databases may be implemented as fault-tolerant, relational, scalable, secure databases such as Oracle or Sybase.

The operating system 507 may facilitate resource management and operation of the computer system 500. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 517 may facilitate display, execution, interaction, manipulation, or operation of program components through textual or graphical facilities. For example, user interfaces may provide computer interaction interface elements on a display system operatively connected to the computer system 500, such as cursors, icons, check boxes, menus, scrollers, windows, widgets, etc. Graphical 3 (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 500 may implement a web browser 508 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS), Secure Sockets Layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the computer system 500 may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 500 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, nonvolatile memory, hard drives, CD ROMs, DVDs, flash drives, disks, and any other known physical storage media.

Advantages of the embodiment of the present disclosure are illustrated herein.

Embodiment of the present disclosure provides enhanced security for computing devices as the colorable grid cells are not necessarily adjacent to each other.

In an embodiment of the present disclosure, the pattern arrangement increases the complexity of the pattern and also increases the total number of patterns available significantly.

In an embodiment of the present disclosure, the finger swipe marks on the display screen of the device will not enable a hacker to unlock the device.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 3 and 4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 100 | Computing device |
| 102 | Processor |
| 104 | Memory |
| 106 | Interface |
| 108 | Display |
| 110 | Pattern Storage Module |
| 112 | Pattern Verification Module |
| 114 | Order Verification Module |
| 116 | Counter Module |
| 118 | Other Modules |
| 120 | Predefined Pattern |
| 122 | Predefined counter value |
| 124 | Other Data |
| 500 | Computer System |
| 501 | I/O Interface |
| 502 | Processor |
| 503 | Network Interface |
| 504 | Storage Interface |
| 505 | Memory |
| 506 | User Interface Application |
| 507 | Operating System |
| 508 | Web Browser |
| 511 | Input Device |
| 512 | Output Device |

1. A method for authenticating access to a computing device, comprising:
providing, by a processor of the computing device, a user interface on a display of the computing device, wherein the user interface comprises a grid comprising a plurality of colorable grid cells and a plurality of colors to be filled in the plurality of colorable grid cells;
receiving, by the processor, a pattern from the user, wherein the pattern comprises a plurality of colored grid cells and order of coloring of the plurality of colored grid cells;
comparing, by the processor, the pattern received from the user with a predefined pattern; and
authenticating, by the processor, access to the computing device based on the comparison.

2. The method as claimed in claim 1 further comprising providing access to the computing device upon determining the pattern received from the user to be matching with the predefined pattern.

3. The method as claimed in claim 1, wherein the predefined pattern is defined by a user of the computing device, said predefined pattern comprises a plurality of predefined colored grid cells and a predefined order of coloring of the plurality of predefined colored grid cells.

4. The method as claimed in claim 1, wherein comparing the pattern received from the user with the predefined pattern comprises:
comparing the plurality of colored grid cells with the plurality of predefined colored grid cells; and
comparing order of coloring of the plurality of grid cells with predefined order of coloring of the plurality of predefined colored grid cells.

5. The method as claimed in claim 1 further comprising:
incrementing a counter each time upon determining the pattern received from the user to be different from the predefined pattern; and
resetting the incremented counter upon determining the pattern received from the user to be matching with the predefined pattern.

6. The method as claimed in claim 5 further comprising restricting access to the computing device upon determining value of the counter to be exceeding a predefined counter value.

7. The method as claimed in claim 1, further comprising hiding display of a colored grid cell of the plurality of colored grid cells subsequently upon receiving selection of the colored grid cell from the user.

8. A computing device for providing authenticated access comprising:
a processor; and
a memory communicatively coupled to the processor, wherein the memory stores processor-executable instructions, which, on execution, causes the processor to:
providing a user interface on a display of the computing device, wherein the user interface comprises a grid comprising a plurality of colorable grid cells and a plurality of colors to be filled in the plurality of colorable grid cells;
receiving a pattern from the user, wherein the pattern comprises a plurality of colored grid cells and order of coloring of the plurality of colored grid cells;
comparing the pattern received from the user with a predefined pattern; and
authenticating access to the computing device based on the comparison.

9. The computing device as claimed in claim 8, wherein the access to the computing device is provided upon determining the pattern received from the user to be matching with the predefined pattern.

10. The computing device as claimed in claim 8, wherein the predefined pattern is defined by a user of the computing device, said predefined pattern comprises a plurality of predefined colored grid cells and a predefined order of coloring of the plurality of predefined colored grid cells.

11. The computing device as claimed in claim 8, wherein comparing the pattern received from the user with the predefined pattern comprises:
comparing the plurality of colored grid cells with the plurality of predefined colored grid cells; and
comparing order of coloring of the plurality of grid cells with predefined order of coloring of the plurality of predefined colored grid cells.

12. The computing device as claimed in claim 8, wherein the processor is further configured to:
increment a counter each time upon determining the pattern received from the user to be different from the predefined pattern; and
reset the incremented counter upon determining the pattern received from the user to be matching with the predefined pattern.

13. The computing device as claimed in claim 12, wherein the processor is further configured to restrict access to the computing device upon determining value of the counter to be exceeding the predefined counter value.

14. The computing device as claimed in claim 8, wherein the processor is further configured to hide display of a colored grid cell of the plurality of colored grid cells subsequently upon receiving selection of the colored grid cell from the user.

15. A non-transitory computer readable medium including instructions stored thereon that when processed by at least one processor cause a system to perform operations comprising:
providing a user interface on a display of the computing device, wherein the user interface comprises a grid comprising a plurality of colorable grid cells and a plurality of colors to be filled in the plurality of colorable grid cells;
receiving a pattern from the user, wherein the pattern comprises a plurality of colored grid cells and order of coloring of the plurality of colored grid cells;
comparing the pattern received from the user with a predefined pattern; and
authenticating access to the computing device based on the comparison.

16. The medium as claimed in claim 15, wherein the access to the computing device is provided upon determining the pattern received from the user to be matching with the predefined pattern.

17. The medium as claimed in claim 15, wherein operations of comparing the pattern received from the user with the predefined pattern further comprising:
comparing the plurality of colored grid cells with the plurality of predefined colored grid cells; and
comparing order of coloring of the plurality of grid cells with predefined order of coloring of the plurality of predefined colored grid cells.

18. The medium as claimed in claim 15, wherein the instructions further cause the at least one processor to perform operations comprising:
incrementing a counter each time upon determining the pattern received from the user to be different from the predefined pattern; and
resetting the incremented counter upon determining the pattern received from the user to be matching with the predefined pattern.

19. The medium as claimed in claim 18, wherein the instructions further cause the at least one processor to perform operations comprising restricting access to the computing device upon determining value of the counter to be exceeding a predefined counter value.

20. The medium as claimed in claim 15, wherein the instructions further cause the at least one processor to perform operations comprising hiding display of a colored grid cell of the plurality of colored grid cells subsequently upon receiving selection of the colored grid cell from the user.
